(19) United States
(12) Patent Application Publication
(10) Pub. No.: US 2019/0114358 A1
(43) Pub. Date: Apr. 18, 2019

(54) METHOD AND SYSTEM FOR RETRIEVING REGULATORY INFORMATION

(71) Applicant: J. J. Keller & Associates, Inc., Neenah, WI (US)

(72) Inventor: Frances A. Crowley Yuronich, Omro, WI (US)

(21) Appl. No.: 15/782,106

(22) Filed: Oct. 12, 2017

(51) Int. Cl. G06F 17/30; G10L 13/02; G10L 15/22; G10L 15/26

(52) U.S. Cl. CPC G06F 17/30654; G06F 17/3043; G06F 17/30663; G10L 15/142; G10L 15/22; G10L 15/26; G10L 13/02

(57) ABSTRACT

System and method for retrieving regulatory information. In one example, the system, method, and apparatus include receiving a voice-based query associated with one or more federal and state regulations; determining the word context of the voice-based query based on historically used words within the voice-based query, and a position of a computing device, each of the historically used words within the voice-based query and the position of the computing device having different weight values; performing a keyword based on the word context of the voice-based query, determining a federal and state regulation associated with the voice-based query; retrieving the federal and state regulation and one or more rules associated with the federal and state regulation; generating a voice-based answer in response to the keyword search being successful; and updating the proprietary content management system based on the keyword.

### FIELD

Embodiments relate to methods and systems for retrieving regulatory information utilizing an expert system that facilitates and accepts queries made in common parlance rather than queries containing formal terms and subject matter jargon.

### BACKGROUND

Employers, employees, consumers, safety personnel and others often seek information related to various state and federal regulations that govern safety and legal aspects related to particular industries. Examples of regulations include among others the Occupational Safety and Health Administration (OSHA) regulations (allows for providing a safe and healthful workplace), Department of Transportation (DoT) regulations (provides for safe, efficient transportation system), Federal Motor Carrier Safety Administration (FMCSA), Environment Protection Agency (EPA), Department of Labor (DOL), Department of Energy (DOE), etc. Typical approaches to providing and retrieving regulatory information are based on a static structure that navigate the user to the information they require through a predefined logic structure. This type of approach is typically not tailored to the user and do not typically engage the user in a multiple step interaction (as opposed to a conversational dialog), wherein the information is elicited from and conveyed to the customer. In addition, retrieving the relevant regulatory information can be time-consuming.

### SUMMARY

Embodiments provided herein allows a user (for example, a safety professional) to retrieve federal and state regulatory information in an interactive manner using an expert system thereby avoiding formal language and jargon specific to the state and federal regulations. The system is also configured to accept queries and operate in an interactive manner without the recitation of reference numbers for federal and state regulations. Embodiments provide users instant access to ask and receive answers for questions related to regulatory information via their smartphone or using a dedicated device (for example, a base unit of a commercial motor vehicle). Systems and methods provided allow for using multiple areas of regulation such that DOT, OSHA, and Environmental regulation and providing an answer that is cross-functional in nature. For example, is a user asks the following question, “if my driver is loading a cargo on a flatbed and falls from the load, is it recordable?.” The answer to this question would include the answer for DOT and OSHA and based on the particular situation may also provide questions in return such as “Do you need to locate the nearest emergency facility?.” Systems and methods described herein allow instant access to information, experts, and cross-functional regulatory bodies thereby reducing the transaction time involved while retrieving regulatory information. In the past, databases were not updated based on the results of various historic keyword searches. Updating the databases based on the results of keyword searches allows for faster and more accurate searching the next time a similar questions is asked.

One embodiment provides a computing device including an electronic processor that is configured to receive a voice-based query associated with one or more federal and state regulations; determine a word context of the voice-based query based on historically used words within the voice-based query, and a position of the computing device, wherein each of the historically used words within the voice-based query and the position of the computing device having different weight values; perform a keyword search on a plurality of databases based on the word context of the voice-based query, the plurality of databases including a proprietary content management system, a state regulatory content database and a federal regulatory content database; determine a federal regulation and state regulation associated with the voice-based query; retrieve the federal regulation, the state regulation and one or more rules associated with the federal regulation and the state regulation from the plurality of databases; generate a voice-based answer in response to the keyword search being successful, wherein the voice-based answer is associated with retrieved federal and state regulation and the one or more rules related to the federal regulation and the state regulation; generate a follow-up voice-based query to receive additional information from the user in response to the keyword search not being successful; and update the proprietary content management system based on the keyword search.

Another embodiment provides a method for retrieving regulatory information. The method includes receiving, with an electronic processor, a voice-based query associated with one or more federal and state regulations; determining, with the electronic processor, a word context of the voice-based query based on historically used words within the voice-based query and a position of the computing device, wherein each of the historically used words within the voice-based query and the position of the computing device having different weight values; performing, with the electronic processor, a keyword search on a plurality of databases based on the word context of the voice-based query, the plurality of databases including a proprietary content management system, a state regulatory content database and a federal regulatory content database; determining, with the electronic processor, a federal regulation and a state regulation associated with the voice-based query; retrieving, with the electronic processor, the federal regulation, the state regulation and one or more rules associated with the federal regulation and the state regulation from the plurality of databases; generating, with the electronic processor, a voice-based answer in response to the keyword search being successful, wherein the voice-based answer is associated with retrieved federal and state regulation and the one or more rules related to the federal regulation and the state regulation; generating, with the electronic processor, a follow-up voice-based query to receive additional information from the user in response to the keyword search not being successful; and updating, with the electronic processor, the proprietary content management system based on the keyword search.

Another embodiment provides a non-transitory computer-readable medium containing computer-executable instructions that when executed by one or more processors in a computing device cause the one or more processors to receive, with an electronic processor, a voice-based query associated with one or more federal and state regulations; determine, with the electronic processor, a word context of the voice-based query based on a historically used words within the voice-based query, and a position of the computing device, wherein each of the historically used words within the voice-based query and the position of the computing device having different weight values; perform, with the electronic processor, a keyword search on a plurality of databases based on the word context of the voice-based query, the plurality of databases including a proprietary content management system, a state regulatory content database and a federal regulatory content database; determine, with the electronic processor, a federal regulation and a state regulation associated with the voice-based query; retrieve, with the electronic processor, the federal regulation, the state regulation and one or more rules associated with the federal regulation and the state regulation from the plurality of databases; generate, with the electronic processor, a voice-based answer in response to the keyword search being successful, wherein the voice-based answer is associated with retrieved federal and state regulation and the one or more rules related to the federal regulation and the state regulation; generate, with the electronic processor, a follow-up voice-based query to receive additional information from the user in response to the keyword search not being successful; and updating, with the electronic processor, the proprietary content management system based on the keyword search.

Other aspects of various embodiments will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system for retrieving regulatory information, in accordance with some embodiments.

FIG. 2A is a block diagram of a computing device shown in FIG. 1, in accordance with some embodiments.

FIG. 2B illustrates various software programs stored in the memory shown in FIG. 2A, in accordance with some embodiments.

FIG. 3 illustrates steps associated with downloading a regulatory information retrieval application, in accordance with some embodiments.

FIG. 4 illustrates steps associated with user engagement with the regulatory information retrieval application, in accordance with some embodiments.

FIG. 5 is a flow chart illustrating steps associated with regulatory information retrieval using the regulatory information retrieval application, in accordance with some embodiments.

FIGS. 6a, 6b, and 6c is a flow chart of interactions between a user and the regulatory information retrieval application during retrieval of regulatory information, in accordance with some embodiments.

FIG. 7 is a flow chart of a method for locating an answer for a user initiated query related to regulatory information, in accordance with some embodiments.

FIG. 8 is a flow chart of a method for retrieving regulatory information, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system, apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. It should also be noted that a plurality of hardware and software based devices may be utilized to implement various embodiments.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

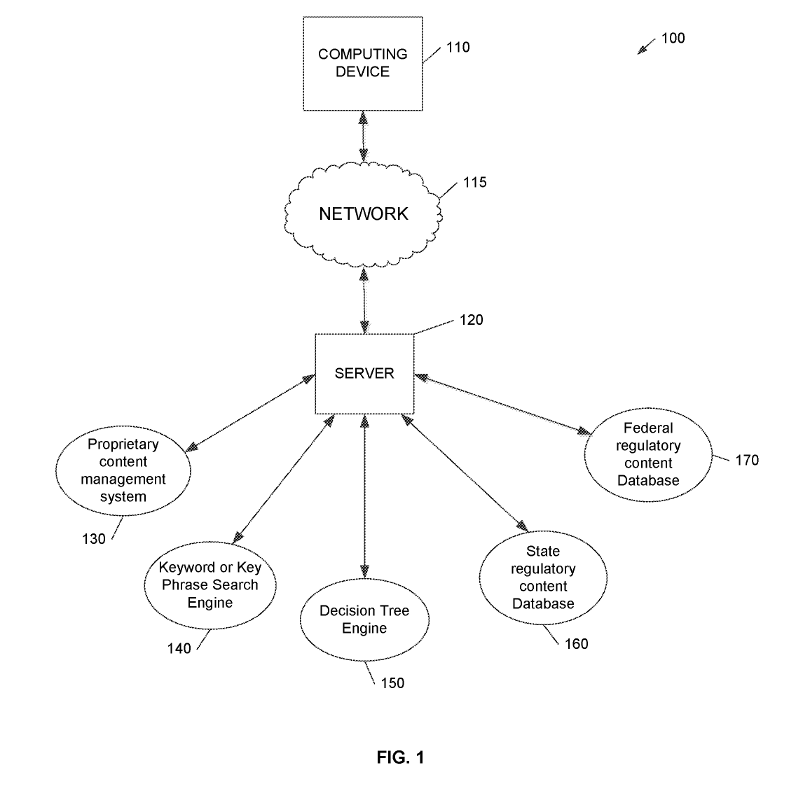

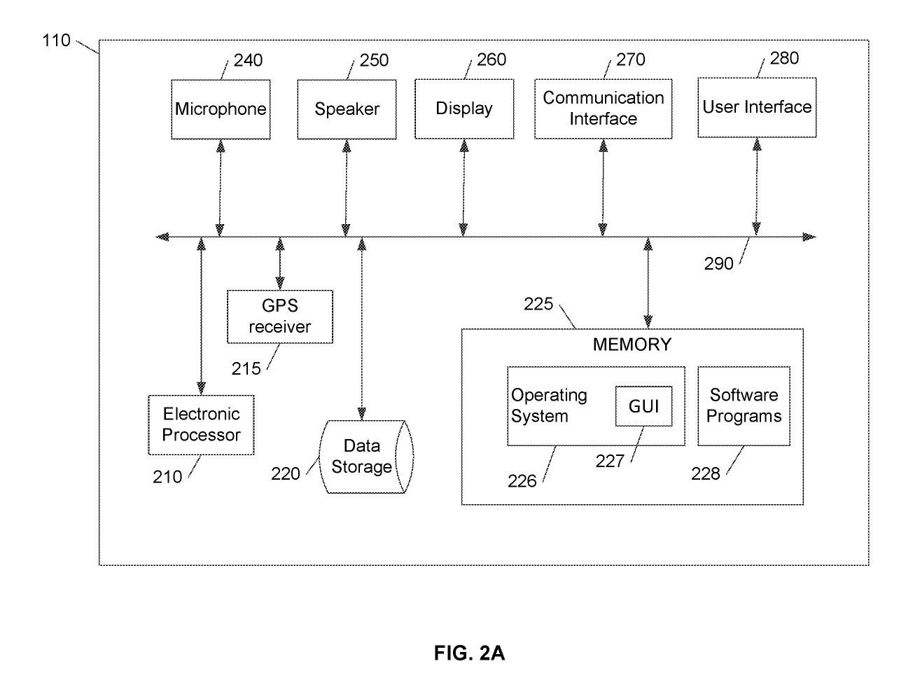

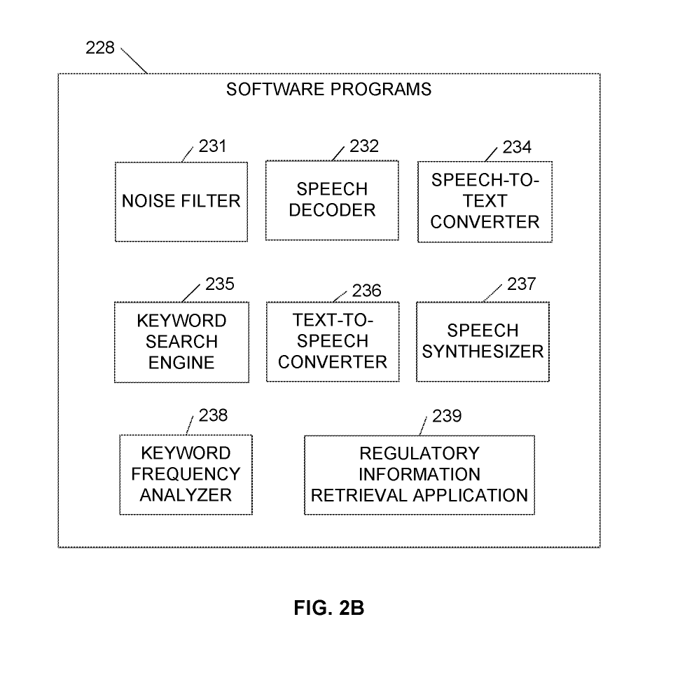

FIG. 1 is a block diagram of a system 100 for retrieving regulatory information, in accordance with some embodiments. System 100 includes a computing device 110 connected to a server 120 via a network 115. In some embodiments, the server 120 is connected to a proprietary content management system (CMS) 130, keyword search engine 140, decision tree engine 150, a state regulatory content database 160, and a federal regulatory content database 170. In some embodiments, the decision tree engine 150 is created based on commonly questioned regulatory questions. In some embodiments, the proprietary content management system 130 includes information, notes, excerpts and commentary associated with several federal and state regulations and regulatory bodies that can be accessed using a regulatory information retrieval application 239 (shown in FIG. 2b). In some embodiments, the key word search engine is configured to perform key phrase searches.

FIG. 2A is a block diagram of the computing device 110 shown in FIG. 1, in accordance with some embodiments. The computing device 110 may combine hardware, software, firmware, and system on-a-chip technology to implement the method of retrieving regulatory information as provided herein. In some embodiments, the computing device 110 includes an electronic processor 210, a position information device (for example a global positioning system (“GPS”) receiver) 215, a data storage device 220, a memory 225, a microphone 240, a speaker 250, a display 260, a communication interface 270, a user interface 280 that can include a variety of components for example, an electronic mouse, a keyboard, a trackball, a stylus, a touch-pad, a touchscreen, a graphical user interface (GUI)) and others. The computing device 110 also includes a bus 290 that interconnects the components of the device. Some examples of the computing device 110 includes a smart phone, a tablet, a laptop, a wearable device, a base unit for a commercial motor vehicle, etc.

In the example illustrated the memory 225 includes an operating system 226 and one or more software programs 228. In some embodiments, the operating system 226 includes a graphical user interface (GUI) program or GUI generator 227 that provides a human-computer interface. The graphical user interface generator 227 may cause an interface to be displayed that includes icons, menus, text, and other visual indicators or graphical representations to display information and related user controls. In some embodiments, the graphical user interface generator 227 is configured to interact with a touchscreen to provide a touchscreen-based user interface. In one embodiment, the electronic processor 210 may include at least one microprocessor and be in communication with at least one microprocessor. The microprocessor interprets and executes a set of instructions stored in the memory 225. The one or more software programs 228 may be configured to implement the methods described herein. In some embodiments, the memory 225 includes, for example, random access memory (RAM), read-only memory (ROM), and combinations thereof. In some embodiments, the memory 225 has a distributed architecture, where various components are situated remotely from one another, but may be accessed by the electronic processor 210.

The GPS receiver 211 includes an antenna (not shown), which can be either internal or external to the computing device 110. Based on data received by the antenna from one or more satellites, the GPS receiver 211 provides positioning information to the electronic processor 210. The positioning information can include coordinates (for example, latitude and longitude coordinates), a speed, a heading, a time, and a quality value. In some embodiments, the GPS receiver 211 updates the positioning information at a predetermined frequency (for example, approximately once per second).

The data storage device 220 may include a non-transitory, machine-readable storage medium that stores, for example, one or more databases. In one example, the data storage device 220 also stores executable programs, for example, a set of instructions that when executed by one or more processors cause the one or more processors to perform the one or more methods describe herein. In one example, the data storage device 220 is located external to the computing device 110.

The communication interface 270 provides the computing device 110 a communication gateway with an external network (for example, a wireless network, the internet, etc.). The communication interface 270 may include, for example, an Ethernet card or adapter or a wireless local area network (WLAN) integrated circuit, card or adapter (for example, IEEE standard 802.11a/b/g/n). The communication interface 270 may include address, control, and/or data connections to enable appropriate communications with the external network.

The user interface 280 provides a mechanism for a user to interact with the computing device 110. As noted above, the user interface 280 includes input devices such as a keyboard, a mouse, a touch-pad device, and others. In some embodiments, the user interface 280 interacts with or is controlled by software programs including speech-to-text and text-to-speech converters. In some embodiments, the user interface 280 includes a command language interface, for example, a software-generated command language interface that includes elements configured to accept user inputs, for example, program-specific instructions or data. In some embodiments, the software-generated components of the user interface 280 includes menus that a user may use to choose particular commands from lists displayed on the display 260.

The bus 290, or other component interconnection, provides one or more communication links among the components of the computing device 110. The bus 290 may be, for example, one or more buses or other wired or wireless connections. The bus 290 may have additional elements, which are omitted for simplicity, such as controllers, buffers (for example, caches), drivers, repeaters, and receivers, or other similar components, to enable communications. The bus 290 may also include address, control, data connections, or a combination of the foregoing to enable appropriate communications among the aforementioned components.

In some embodiments, the electronic processor 210, the display 260, and the memory 230, or a combination thereof may be included in one or more separate devices. For example, in some embodiments, the display may be included in the computing device 110 (for example, a portable communication device such as a smart phone, tablet, etc.), which is configured to transmit an electronic message to the server 120 including the memory 225 and one or more other components illustrated in FIG. 1. In this configuration, the electronic processor 210 may be included in the portable communication device or another device that communicates with the server 120 over a wired or wireless network or connection.

FIG. 2B illustrates various software programs stored in the memory 225 shown in FIG. 2A, in accordance with some embodiments. In the example shown, the software programs 228 include a noise filter 231, a speech decoder 232, a speech-to-text converter 234, a keyword search engine 235, a text-to-speech converter 236, a speech synthesizer 237, a keyword frequency analyzer 238, and a regulatory information retrieval application 239. In some embodiments, the electronic processor 210 may be included in the computing device 110 and may execute the software programs 228 stored on the server 120 to access and process data as described herein.

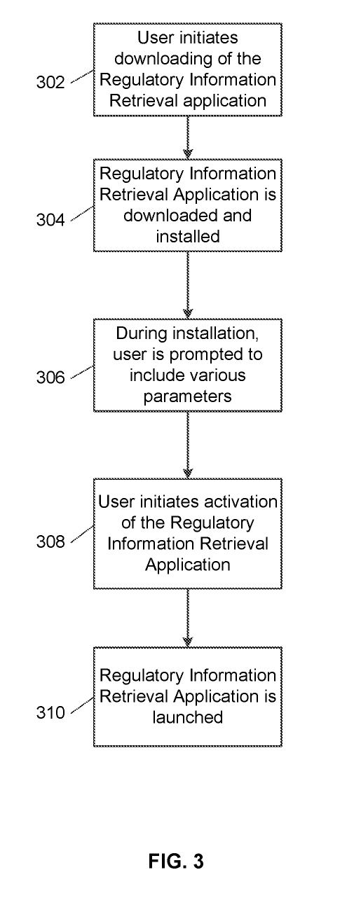

FIG. 3 illustrates steps associated with downloading the regulatory information retrieval application 239, in accordance with some embodiments. At block 302, a user initiates the download of the regulatory information retrieval application 239 from a server 120. At block 304, the regulatory information retrieval application 239 is downloaded and installed in the memory 225 of a computing device 110. At block 306, the user is prompted to include various parameters (for example, user profile, contact information, company information, industry information, etc.) associated with the user along with the areas of business associated with the user. At block 308, the user initiates activation of the regulatory information retrieval application 239 following which the regulatory information retrieval application 239 is launched on the computing device 110.

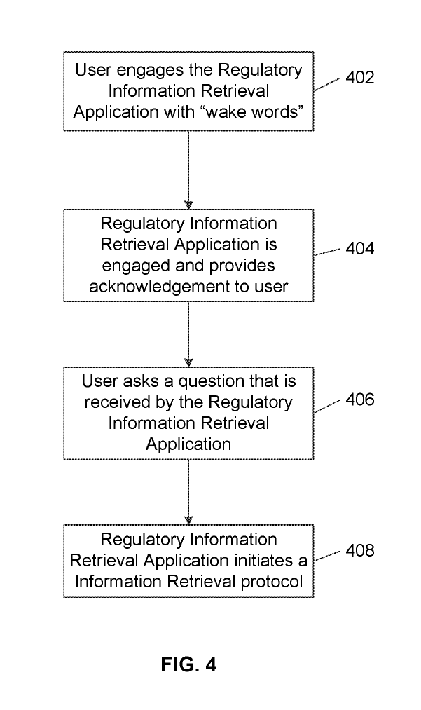

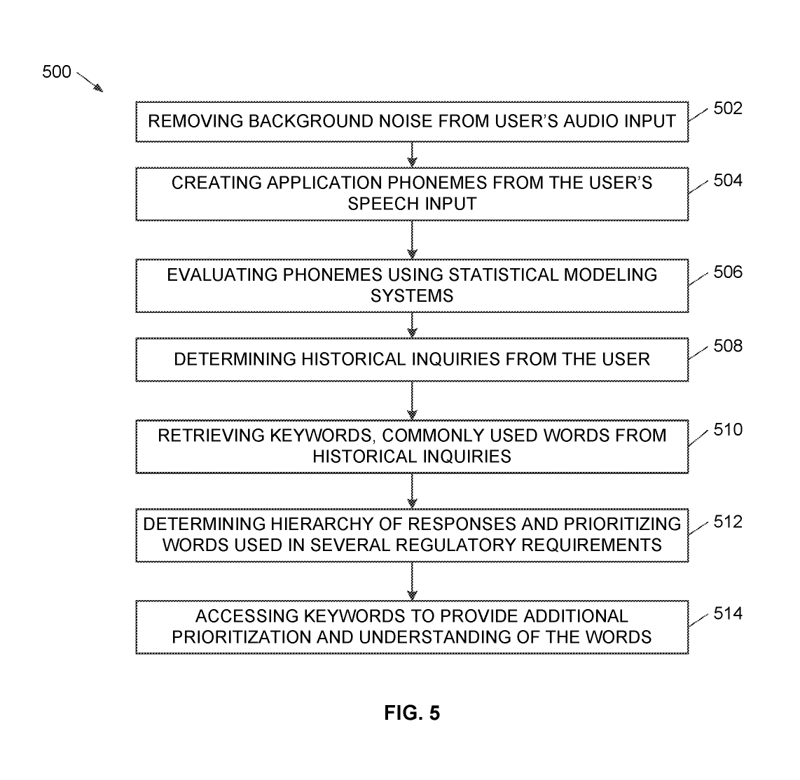

FIG. 4 illustrates steps associated with user engagement with the regulatory information retrieval application 239, in accordance with some embodiments. At block 402, when a user is interested in posing a question for the regulatory information retrieval application 239, the user engages the regulatory information retrieval application using “wake words” that will be received by the microphone 240 and processed using electronic processor 210. In some embodiments, the “wake words” may be programmable by the user. In some embodiments, the “wake words” may be a set of words that is pre-programmed at installation of the regulatory information retrieval application 239. At block 404, when the regulatory information retrieval application 239 receives the appropriate “wake words” using the microphone 240, the regulatory information retrieval application 239 is engaged. In some embodiments, the regulatory information retrieval application 239 provides an acknowledgement to the user. Upon providing the acknowledgement, the regulatory information retrieval application 239 is ready to receive queries from the user. At block 406, the user asks a question that is received by the regulatory information retrieval application 239. The speech data associated with the question from the user is received at microphone 240. At block 408, the regulatory information retrieval application initiates an information retrieval protocol shown in FIG. 5.

FIG. 5 is a flow of method 500 illustrating steps associated with regulatory information retrieval using the regulatory information retrieval application, in accordance with some embodiments. At block 502, the method 500 includes removing background noise from user's speech input using noise filter 231. At block 504, the method 500 includes creating application phonemes from the user's audio input. At block 506, the method 500 includes evaluating phonemes using statistical modeling systems. In some embodiments, the phonemes are evaluated using statistical modeling system including a hidden Markov model and the output includes a word context. Word contexts allow the regulatory information retrieval application 239 to understand questions associated with the user's speech input. At block 508, the method 500 includes determining historical inquiries from the user. At block 510, the method 500 includes retrieving keywords and commonly used words from historical inquiries. In some embodiments, the regulatory information retrieval application 239 references historical inquiries from the user and retrieves keywords or commonly used words from historical inquiries. At block 512, the method 500 includes determining a hierarchy of responses and prioritizing words used in several regulatory requirements. In some embodiments, the regulatory information retrieval application 239 determines the hierarchy of responses and this information is used to prioritize words that may be used by more than one regulatory body (for example, DOT and OSHA). At block 514, the method 500 includes accessing keywords to provide additional prioritization and understanding of the words. In some embodiments, the regulatory information retrieval application 239 accesses the keyword search engine 140 to prioritize and/or understand words that may not be commonly found in existing speech recognition modules. In some embodiments, the data in the historical query and/or keywords database is used to create training data to assist the regulatory information retrieval application 239 to determine the context of several words received by computing device 110.

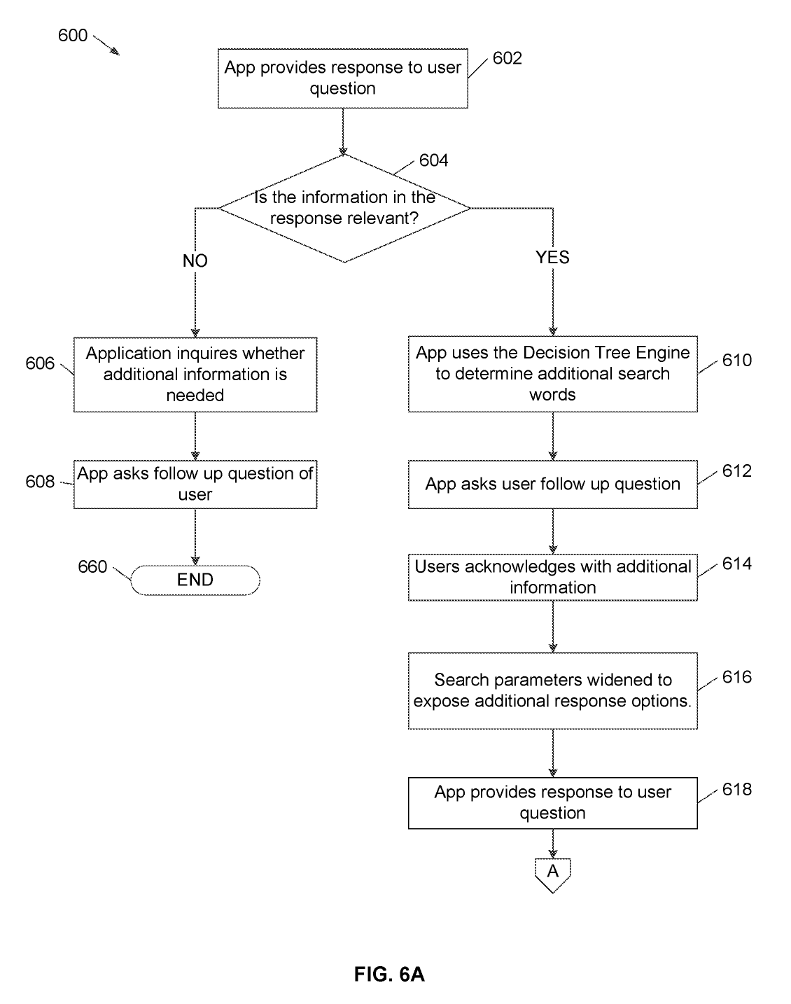

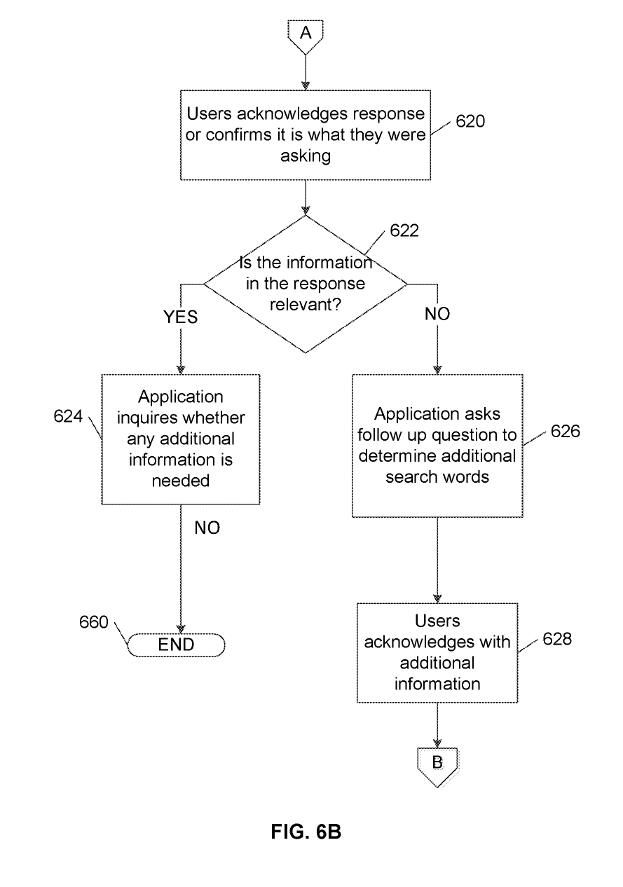

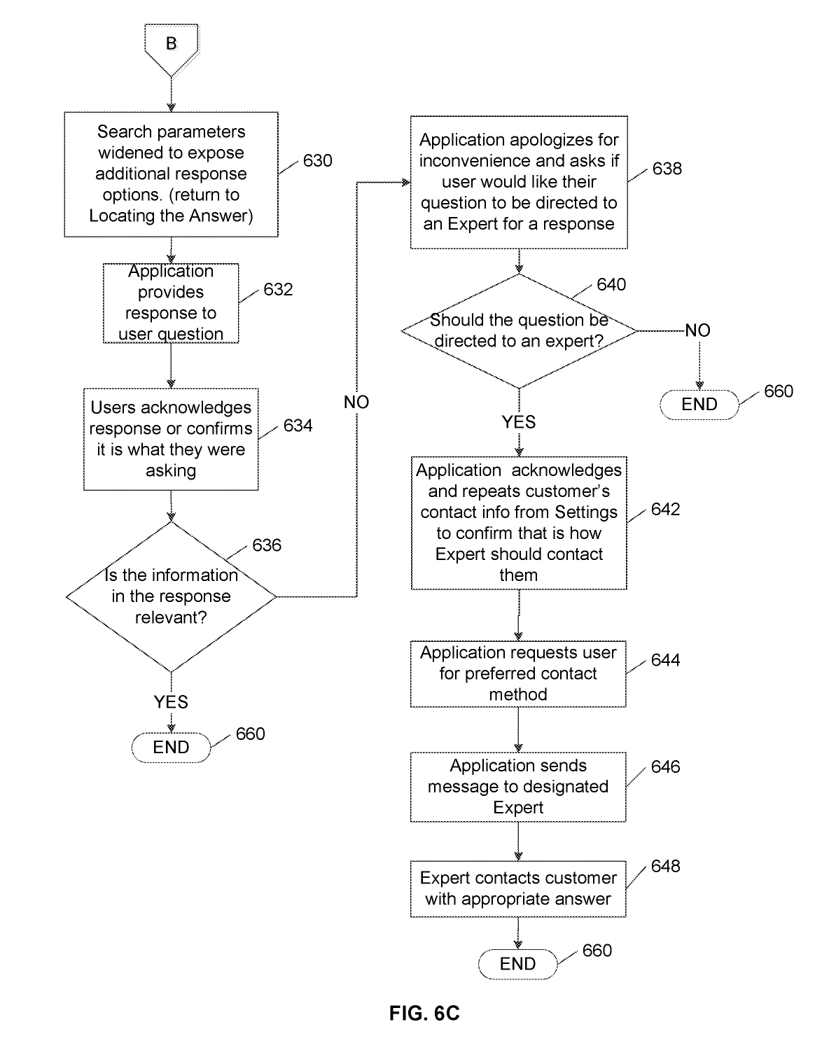

FIGS. 6a, 6b, and 6c is a flow chart of method 600 describing the interactions between a user and the regulatory information retrieval application 239 during retrieval of regulatory information, in accordance with some embodiments. At block 602, the regulatory information retrieval application 239 provides a response to a user's question. At block 604, the method 600 checks whether the information provided in a particular response is relevant to the user. If the information provided in a particular response is not relevant to the user, the method 600 proceeds to block 606. At block 606, the regulatory information retrieval application 239 inquires whether additional information is needed.

At block 608, the regulatory information retrieval application 239 asks follow-up question to the user. At block 660, the method 600 terminates. On the other hand, if the particular response is relevant to the user, the method 600 proceeds to block 610. At block 610, the method 600 uses the decision tree engine 150 to determine additional search words. At block 612, the regulatory information retrieval application 239 asks the user a follow-up question. At block 614, the users acknowledges with additional information. At block 616, the search parameters are widened to expose additional response options. At block 618, the regulatory information retrieval application 239 provides a response to the user's question.

At block 620, the user responds to or acknowledges the response to the regulatory information retrieval application 239. At block 622, the user responds to or acknowledges that the response from the regulatory information retrieval application 239 is adequate or that the response from the regulatory information retrieval application 239 is inadequate or not related to the user's question. In some embodiments, the user may acknowledge with words such as “YES,” “Thank You,” or “OK,” which will be recognized by the regulatory information retrieval application 239 that the user is satisfied with the response. In some embodiments, the user may respond back with words such as “NO,” “NOT OK,” NOT RELATED,” or “NOT APPLICABLE” to inform the regulatory information retrieval application 239 that the response is not adequate or is not relevant to the user's question. In some embodiments, the user may request the regulatory information retrieval application 239 to repeat the answer by using words such as “REPEAT,” or “PLAY AGAIN.”

At block 622 the regulatory information retrieval application 239 determines whether the user is satisfied with a response or not. At block 624, when the user is satisfied with the response from the regulatory information retrieval application 239, the application inquires whether any additional information is needed. At block 626, when the user is not satisfied with the response from the regulatory information retrieval application 239, the regulatory information retrieval application 239 asks a follow-up question to determine additional search words. At block 628, the user acknowledges back with additional information necessary for the regulatory information retrieval application 239 to perform further searches to obtain an answer for the user.

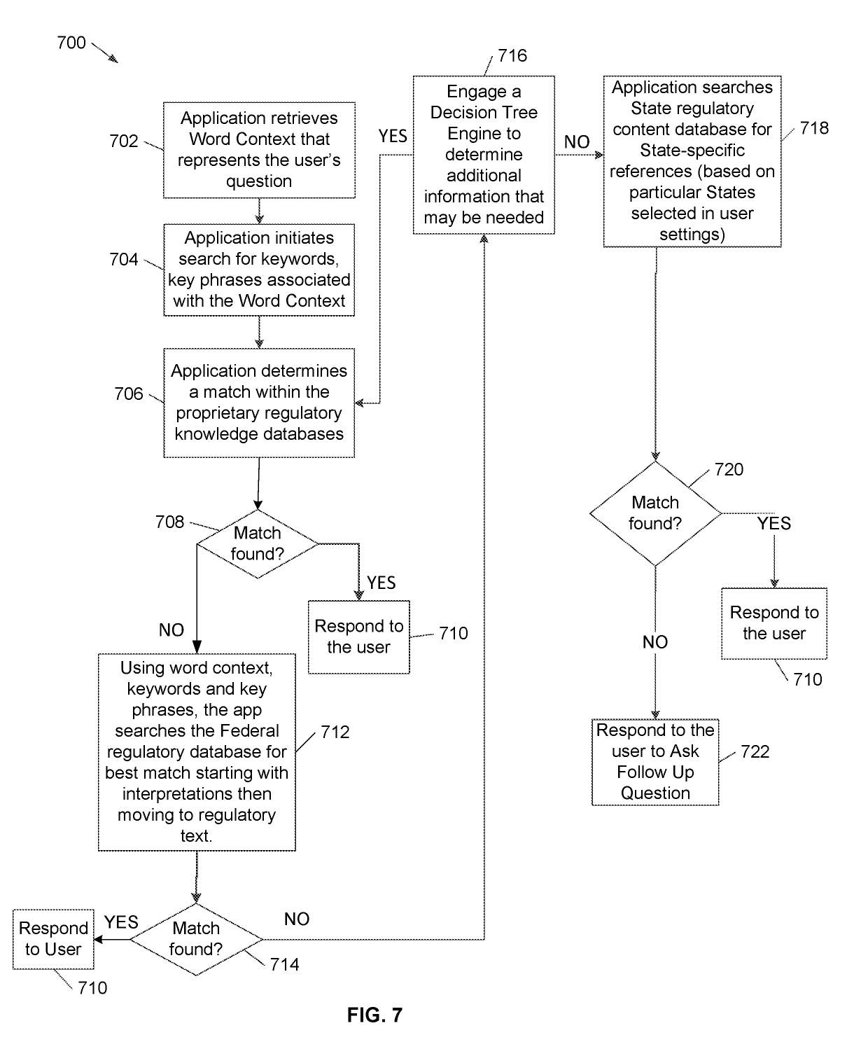

At block 630, the regulatory information retrieval application 239 widens the search parameters to include the additional information provided by the user at block 628 and proceeds to block 702 (FIG. 7) for locating the answer. At block 632, the regulatory information retrieval application 239 provides the response to the user's question. At block 634 the user acknowledges the response or confirms to the regulatory information retrieval application 239. At block 636, the user determines whether the information in the response is relevant or similar to that in block 622. If the response is adequate and relevant to the user's question the method 600 ends at block 660. If the response is not relevant to the user's question the method 600 proceeds to block 638. At block 638, the regulatory information retrieval application 239 provides an apology to the user and whether the user would like their question directed to an expert for response. At block 640, the user determines whether their question needs to be directed to an expert. If the question is being directed to the expert, the method 600 proceeds to block 642. At block 642, the regulatory information retrieval application 239 acknowledges and repeats the customer's contact information from the user settings to confirm how (for example, by telephone, email, text message, etc.) the expert should contact the user. At block 644, the regulatory information retrieval application 239 requests the user for a preferred contact method. At block 646, the regulatory information retrieval application 239 sends message to designate an expert. At block 648, the expert contacts the user with the appropriate answer. The method 600 ends at block 660

FIG. 7 is a flow chart of a method 700 for locating an answer to a user initiated query related to regulatory information using the regulatory information retrieval application 239, in accordance with some embodiments. At block 702 of method 700, the regulatory information retrieval application 239 retrieves a word context representing the user's question. At block 704, the regulatory information retrieval application 239 initiates a search for a keyword or a key phrase associated with the word context retrieved at block 702. At block 706, the regulatory information retrieval application 239 determines a match within the proprietary content management system 130 the search for the keyword or a key phrase.

At block 708, the method 700 determines whether a match associated with the keyword search or key phrase search at block 704 has been found. In response to determining a match within the proprietary regulatory content database at block 708, the method 700 proceeds to block 710. At block 710, the application responds to the user by conveying that no match has been found (for example, the regulatory information retrieval application 239 may generate a response stating “No Information Available”). In response to determining that there is no match at block 708, the method 700 proceeds to block 712.

At block 712, the regulatory information retrieval application 239 searches the federal regulatory content database 170 for a best match for the word context, keywords and key phrases representing the user's question. Following block 712, the method 700 proceeds to block 714 where it is determined whether a match has been found or not. In response to a match being found at block 714, the method 700 responds to the user with the results from the search of the federal regulatory content database 170. Similarly, in response to a match not being found at block 714, the method 700 proceeds to block 716. At block 716, the method 700 engages the decision tree engine 150 to determine any additional information needed to perform the search. In response to determining the additional information at block 716, the method 700 proceeds to block 706 to determine a match related to the additional information obtained using the decision tree engine 150. In response to determine that no additional information is necessary to perform the search, the method 700 proceeds to block 718.

At block 718, the regulatory information retrieval application 239 searches the state regulatory content database 160 for state-specific references and information based on the particular state that is selected in user settings. In some embodiments, the regulatory information retrieval application 239 searches for state-specific references and other information based on the location of the user. In some embodiments, regulatory information retrieval application 239 begins a search associated with the interpretation of state and federal regulations prior to conducting a search for regulatory text of the state and federal regulations.

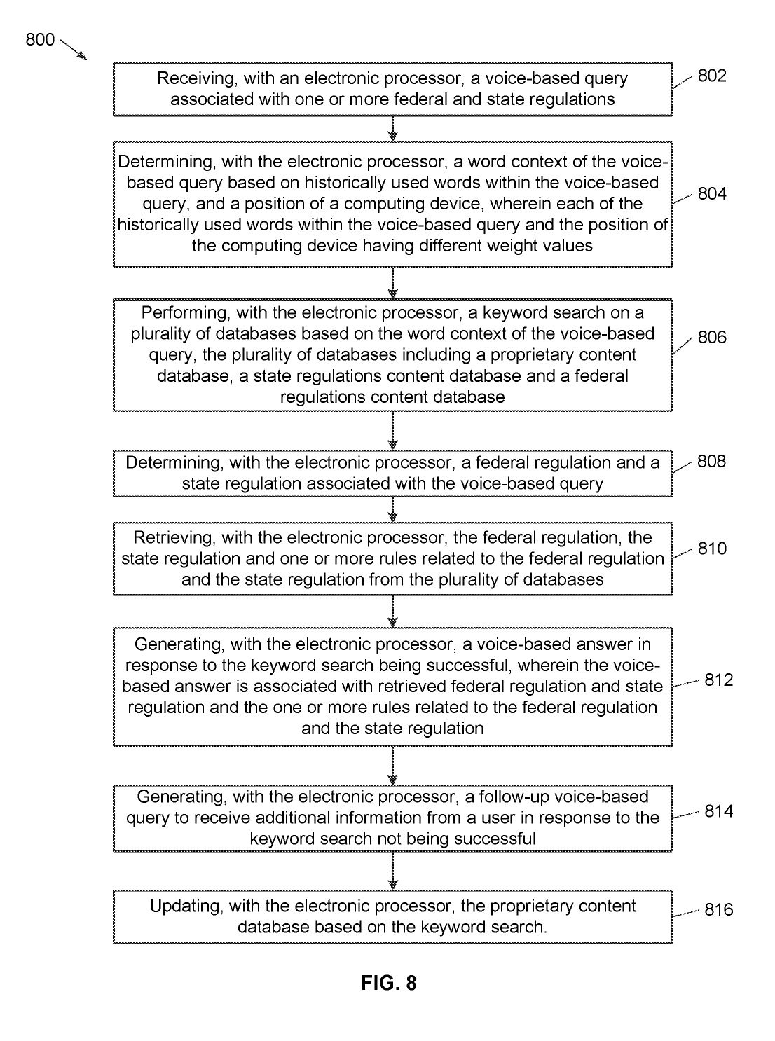

FIG. 8 is a flow chart illustrating a method 800 for retrieving regulatory information, in accordance with some embodiments. At block 802, the method 800 includes receiving, with the electronic processor 210, a voice-based query associated with one or more federal and state regulations. An example for a voice-based query includes the following: “If a driver works somewhere else for 4 hours in the morning then reports for duty here in the afternoon of the same day, do the 4 hours from his morning job count as part of his 14-hour on duty?”

In some embodiments, at block 804, the method 800 includes determining, with the electronic processor 210, a word context of the voice-based query based on historically used words within the voice-based query, and a position of the user, wherein each of the user preference, the historically used words within the voice-based query, and the position of the user are assigned different weighting values or weights. In some embodiments, the word context of the voice-based query is determined based on user preference including a particular type of regulation (for example, OSHA, DOT, DOE, etc.) that the user desires to retrieve information about. For the example given above, the method 800 determines the word context of the query by parsing the query into several components and allocating different scores as follows:

“If a driver”—validate using parameters at block 306 or ask for clarification. In one example the clarification can be—is the driver a commercial driver's license (CDL) driver or a non-CDL driver? Also, is the driver an interstate driver or a Wisconsin intra-state driver (assuming the state has been identified as been identified as Wisconsin—if not, the method may ask for clarification for the identification of the particular state that the driver is licensed in) ? (Score: 5)

“works somewhere else”—use common phrase meaning not working at this company. (Score: 5)

“for 4-hours in the morning”—refers to the time of day. (Score: 4)

“then reports to duty”—Department of Transportation (DOT) phrase referring to record of duty status of on-duty. (Score: 4)

“of the same day”—in context of this question, this is a relevant phrase. (Score: 4)

“do the 4 hours”—forms the reply to be aligned with the form of the question. (Score: 4)

“from his morning”—refers to a time of day. (Score: 3)

“job count as part of his 14-hour on duty”—common DOT phrase referring to record of duty status of on-duty. (Score: 5)

At block 806, the method 800 includes performing, with the electronic processor 210, a keyword search on a plurality of databases based on the word context of the voice-based query. In some embodiments, the plurality of databases includes the proprietary content management system 130, a state regulatory content database 160, and a federal regulatory content database 170. In some embodiments, the keyword search is performed based on a hierarchical order. For example, the keyword search is performed first on the proprietary content management system 130 followed by the federal regulatory content database 170 followed by the state regulatory content database 160. In some embodiments, the keyword search is performed based on the various scores allocated at block 804.

At block 808, the method 800 includes determining, with the electronic processor 210, a federal regulation and a state regulation associated with the voice-based query. In some embodiments, a unique identifier is created if the keyword search results is an answer retrieved from any source other than the proprietary content management system. These unique identifiers along with the respective questions and answers associated with these unique identifiers are stored in the proprietary content management system 130 along with the corresponding date and time of the questions and answers.

At block 810, the method 800 includes retrieving, with the electronic processor 210, the federal regulation, the state regulation and one or more rules associated with the federal and state regulation from the plurality of databases. In one example, the retrieved regulation information is the following:

A non-CDL intrastate Wisconsin driver is not subject to the hours of service limits. Wisconsin has adopted Part 395 of the Federal Regulations with a few exceptions. Part 395 applies to drivers who operate motor vehicles with a gross vehicle weight rating over 26,000 pounds, and drivers operating vehicles of any size transporting a placardable amount of hazardous materials.

In some embodiments, if the driver has a non-CDL operating a moto vehicle under 26000 pounds, and meets the definition of intrastate, he is no subject to the hours of service limits and does not have to report the 4 hours of work he completed prior to coming to work at the new location.

In some embodiments, the success rate associated with the retrieval of relevant federal and state regulations and corresponding rules is logged in the proprietary content management system 130 for each question provided to the regulatory information retrieval application 239. This allows editors to include additional information for questions that have a low success rate.

At block 812, the method 800 includes generating, with the electronic processor 210, a voice-based answer in response to the keyword search being successful. The voice based answer is related to the retrieved federal regulation and state regulation and one or more rules associated with the federal and state regulation in block 810.

At block 814, the method 800 includes generating, with the electronic processor 210, a follow-up voice-based query to receive additional information from the user in response to the keyword search not being successful. Some examples of follow-up voice based query are

“which state is the driver licensed in?,”

“which state is the job going to take place?,”

“Do you have a follow up question?,”

“Do you want additional clarification?” etc.

At block 816, the method 800 includes updating, with the electronic processor, the proprietary content management system 130 based on the keyword search.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An expert system for retrieving regulatory information, the expert system comprising:
a computing device including an electronic processor configured to
receive a voice-based query associated with one or more federal and state regulations;
determine a word context of the voice-based query based on historically used words within the voice-based query, and a position of the computing device, wherein each of the historically used words within the voice-based query and the position of the computing device having different weight values;
perform a keyword search on a plurality of databases based on the word context of the voice-based query, the plurality of databases including a proprietary content management system, a state regulatory content database and a federal regulatory content database;
determine a federal regulation and state regulation associated with the voice-based query;
retrieve the federal regulation, the state regulation and one or more rules associated with the federal regulation and the state regulation from the plurality of databases;
generate a voice-based answer in response to the keyword search being successful, wherein the voice-based answer is associated with retrieved federal and state regulation and the one or more rules related to the federal regulation and the state regulation;
generate a follow-up voice-based query to receive additional information from a user in response to the keyword search not being successful; and
update the proprietary content management system based on the keyword search.

2. The expert system of claim 1, wherein the electronic processor is further configured to perform the keyword search based on a hierarchical order.

3. The expert system of claim 1, wherein the computing device includes an item selected from the group consisting of a smart phone, a tablet, a laptop, and a wearable device.

4. The expert system of claim 1, wherein the electronic processor is further configured to receive data associated with the position of the computing device from a position information device.

5. The expert system of claim 1, wherein the electronic processor is further configured to compare a first result from performing the keyword search using the federal regulatory content database with a second result from performing the keyword search using the state regulatory content database.

6. The expert system of claim 1, wherein the weight value associated with the historically used words within the voice-based query is larger than the weight value associated with the position of the computing device.

7. A method for retrieving regulatory information, the method comprising:
receiving, with an electronic processor, a voice-based query associated with one or more federal and state regulations;
determining, with the electronic processor, a word context of the voice-based query based on historically used words within the voice-based query, and a position of a computing device, wherein each of the historically used words within the voice-based query and the position of the computing device having different weight values;
performing, with the electronic processor, a keyword search on a plurality of databases based on the word context of the voice-based query, the plurality of databases including a proprietary content management system, a state regulatory content database and a federal regulatory content database;
determining, with the electronic processor, a federal regulation and a state regulation associated with the voice-based query;
retrieving, with the electronic processor, the federal regulation, the state regulation and one or more rules associated with the federal regulation and the state regulation from the plurality of databases;
generating, with the electronic processor, a voice-based answer in response to the keyword search being successful, wherein the voice-based answer is associated with retrieved federal and state regulation and the one or more rules related to the federal regulation and the state regulation;
generating, with the electronic processor, a follow-up voice-based query to receive additional information from a user in response to the keyword search not being successful; and
updating, with the electronic processor, the proprietary content management system based on the keyword search.

8. The method of claim 7 wherein performing, with the electronic processor, the keyword search on the plurality of databases includes performing the keyword search based on a hierarchical order.

9. The method of claim 7, further comprising:
comparing a first result from performing the keyword search using the federal regulatory content database with a second result from performing the keyword search using the state regulatory content database.

10. The method of claim 7, wherein generating the voice-based answer in response to the keyword search being successful includes using a text-to-speech converter.

11. The method of claim 7, wherein determining the word context of the voice-based query based on the historically used words within the voice-based query and the position of the computing device includes having the weight value associated with the historically used words within the voice-based query being larger than the weight value associated with the position of the computing device.

12. A non-transitory computer-readable medium containing computer-executable instructions that when executed by one or more processors in a computing device cause the one or more processors to:
receive a voice-based query associated with one or more federal and state regulations;
determine a word context of the voice-based query based on historically used words within the voice-based query, and a position of the computing device, wherein each of the historically used words within the voice-based query and the position of the computing device having different weight values;
perform a keyword search on a plurality of databases based on the word context of the voice-based query;
determine a federal regulation and state regulation associated with the voice-based query;
retrieve the federal regulation, the state regulation and one or more rules associated with the federal regulation and the state regulation from the plurality of databases;
generate a voice-based answer in response to the keyword search being successful, wherein the voice-based answer is associated with retrieved federal and state regulation and the one or more rules related to the federal regulation and the state regulation;
generate a follow-up voice-based query to receive additional information from a user in response to the keyword search not being successful; and
update the proprietary content management system based on the keyword search.

13. The non-transitory computer-readable medium of claim 12, further comprising instructions that when executed by a processor cause the processor to perform the keyword search within a database selected from the group consisting of a proprietary regulatory content database, a state regulatory content database and a federal regulatory content database.

14. The non-transitory computer-readable medium of claim 12, further comprising instructions that when executed by a processor cause the processor to perform the keyword search based on a hierarchical order.

15. The non-transitory computer-readable medium of claim 13, further comprising instructions that when executed by a processor cause the processor to compare a first result from performing the keyword search using the federal regulatory content database with a second result from performing the keyword search using the state regulatory content database.

16. The non-transitory computer-readable medium of claim 12, further comprising instructions that when executed by a processor cause the processor to generate the voice-based answer in response to the keyword search being successful includes using a text-to-speech converter.

17. The non-transitory computer-readable medium of claim 12, further comprising instructions that when executed by a processor cause the processor to determine the word context of the voice-based query based on the historically used words within the voice-based query, and the position of the computing device, wherein the weight value associated with the historically used words within the voice-based query is larger than the weight value associated with the position of the computing device.
